(19) United States
(12) Patent Application Publication
(10) Pub. No.: US 2023/0093739 A1
(43) Pub. Date: Mar. 23, 2023

(54) Sewage Treatment Method

(71) Applicant: Laura Summerlin, Callahan, FL (US)

(72) Inventor: Laura Summerlin, Callahan, FL (US)

(21) Appl. No.: 17/949,751

(22) Filed: Sep. 21, 2022

Related U.S. Application Data
(60) Provisional application No. 63/246,335, filed on Sep. 21, 2021.

(51) Int. Cl. C02F 9/00

(52) U.S. Cl. CPC C02F 9/00; C02F 2303/26; C02F 1/74

(57) ABSTRACT

A method for treating sewage to avoid sludge dumping. The sewage treatment method is a multistage process for sanitizing raw sewage and producing easily managed environmentally safe byproducts. Raw sewage or partially treated sewage is processed to remove and treat any liquids leaving sterilized solids that are compacted for limiting the environmental footprint. The method employs mechanical, thermal, radiation, and chemical treatments to the sewage to produce safe biodegradable materials. The treated final product may be used as fertilizer, fillers, aggregate, or compost.

### CROSS-REFERENCE TO RELATED APPLICATION

The present application claims priority to, and the benefit of, U.S. Provisional Application No. 63/246,335, which was filed on Sep. 21, 2021 and is incorporated herein by reference in its entirety.

### FIELD OF THE INVENTION

The present invention generally relates to a way to treat sewage, and more specifically to a method for treating raw or partially treated sewage to prevent sludge dumping. Accordingly, the present specification makes specific reference thereto. However, it is to be appreciated that aspects of the present invention are also equally amenable to other like applications, devices, and methods of manufacture.

### BACKGROUND

Contaminated water supplies are a public health hazard. Solid sewage waste that is dumped into major rivers and tributaries provides a place for harmful bacteria and pathogens to breed and spread disease. This not only destroys the environment and kills off wildlife that depend on these waterways for food and water, but prevents commercial fishing, swimming, and other major human activities. One aim of treating sewage is to produce an effluent that causes as little water pollution as possible, or to produce an effluent that can be reused. This is achieved by removing contaminants from the sewage. Some estimates believe that over fifty percent of raw sewage is left untreated at the global level.

Germs, viruses, bacteria, microbes, and other pathogens are tiny living things found everywhere in nature and are too small to be seen by the naked eye. These organisms are constantly present and persist in raw sewage in large quantities. A pathogen is a micro-organism that has the potential to cause disease. Sewage treatment processes are designed to mitigate dangers from these organisms and to prevent unnecessary contamination of the environment,

Traditional sewage treatment processes are designed to remove contaminants from sewage to produce an effluent that is suitable for discharge to the surrounding environment or an intended reuse application, thereby preventing water pollution from raw sewage discharges. Sewage generally contains wastewater from households and businesses and possibly pre-treated industrial wastewater. There are a numerous types of sewage treatment processes. These can range from decentralized systems, including on-site treatment systems, to large centralized systems involving a network of pipes and pump stations which convey the sewage to a treatment plant. For cities that have a combined sewer, the sewers will also carry urban stormwater runoff to the sewage treatment plant. Sewage treatment often involves two main stages, called primary and secondary treatment, while advanced treatment also incorporates a tertiary treatment stage with polishing processes and nutrient removal. Secondary treatment can reduce organic matter, which is measured as biological oxygen demand, from sewage, using aerobic or anaerobic biological processes.

Typically, the main criteria for selection of a particular sewage treatment process are desired effluent quality, expected construction and operating costs, availability of land, energy requirements and sustainability aspects. In developing countries and in rural areas with low population densities, sewage is often treated by various individual on-site sanitation systems and not conveyed in sewers. These systems include septic tanks connected to drain fields or on-site sewage systems.

The residue that accumulates in sewage treatment plants is called sludge or biosolids. Sewage sludge is the solid, semisolid, or slurry residual material that is produced as a by-product of wastewater treatment processes. Sludge is mostly water with some amounts of solid material removed from liquid sewage. Sludge management is the end of the treatment process for solids. The sludge or solids that have been removed from wastewater by either primary or secondary treatment must also be processed before it can be disposed or reused. The most common way of getting rid of sludge is to send it to a landfill. One problem with this method is that many landfills are filling up, and settlements are having trouble finding places to put new ones. Some cities that are near the sea send their sludge on a barge out into the ocean for dumping causing water pollution in the ocean.

Accordingly, there is a great need for sludges and other solid waste accumulated in a wastewater treatment process to be treated and disposed of in a safe and effective manner. There is also a need for a beneficial holistic sewage treatment system that kills water borne pathogens. Similarly, there is a need for a method for turning sewage solids into super biodegradable material. There is also a need for a scalable process to deal with treating raw sewage to prevent sludge dumping. Further, there is a need for a treatment method for decreasing incidences of water borne illnesses, promoting better health.

In this manner, the improved method for treating raw sewage of the present invention accomplishes all of the forgoing objectives, thereby providing an easy solution for effectively dealing with sludges accumulated in a wastewater treatment process in a safe and effective manner. A primary feature of the present invention is a novel method for treating and disposing of sewage. The present invention provides a holistic sewage treatment system that kills water borne pathogens. The method is designed to turn sewage into super biodegradable material, sparing our waterways and preventing other environmental contamination. Finally, the improved sewage treatment method of the present invention is capable of preventing incidences of water borne illnesses, promoting better health.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a sewage treatment method for treating an initial sewage mixture. The sewage treatment method is configured for sanitizing and removing fluid from a sewage source, such as wastewater containing biosolids or sludge. The sewage treatment method is useful whether the initial sewage mixture has been pre-treated via a municipal sewage treatment system or whether it has not been pre-treated.

The sewage treatment method begins by transporting the initial sewage mixture via conventional means, such as, but not limited to, pipes or transport vessels. The transport vessels may be lined with silver, copper, or other materials with antimicrobial properties. The transport vessels may be rail carts, tanks, barrels, or any similar mobile transport vessel. The sewage treatment method may be configured to treat small to large quantities of the initial sewage mixture ranging from fifty gallons and up.

The initial sewage mixture is mechanically and chemically treated during an initial processing stage. The initial processing stage provides mechanical manipulation via pulverization. The initial sewage mixture is typically pulverized via a plurality of electrically driven rotary blades. The initial processing stage further includes chemically treating the initial sewage mixture. A plurality of chemical agents are added to the initial sewage mixture during pulverization. The plurality of chemical agents typically include at least a base and an acid. Mechanical pulverization oxygenates the untreated sewage mixture and mixes in the chemical agents simultaneously.

A thickening agent may also be added during the mechanical manipulation of the initial sewage mixture. The thickening agent may include an organic or inorganic thickener. A saline solution may also be used to bathe the mechanically and chemically treated sewage mixture during this step. The saline solution may further include the addition of methane or another polarizing chemical additive as well. Once the initial processing stage is complete, the mechanically and chemically treated sewage mixture is transported to the next stage. Transportation may be accomplished via a plurality of non-stick coated transport vessels, or other traditional transport containers.

The mechanically and chemically treated sewage mixture is then heated sufficiently to kill off unwanted bacteria. Once heated, the heated sewage mixture is transported to the next stage of the process for sanitization by applying radiation to the heated sewage mixture. The radiation source is ultraviolet light. The ultraviolet light is generated via an artificial ultraviolet light source, a natural artificial ultraviolet light source, or a combination thereof. The ultraviolet light is applied for at least six minutes.

Once sanitized, the sanitized sewage mixture is transported to the next step for compaction. The sanitized sewage mixture is compressed at the compaction stage into a compact treated sewage solid byproduct. The compact treated sewage solid byproduct is then safely disposed at the final step of the process at a traditional landfill, for use as fertilizer products, or for use as a building or construction product.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a prior art sewage treatment system via an existing sewage system for use with the present invention in accordance with the disclosed architecture;

FIG. 2 illustrates a primary processing stage and a heat treatment stage of a sewage treatment method of the present invention in accordance with the disclosed architecture;

FIG. 3 illustrates a radiation stage, a compacting stage, and a bathing stage of the sewage treatment method of the present invention in accordance with the disclosed architecture; and

FIG. 4 illustrates a conceptual diagram illustrating the configuration of the sewage treatment method of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The method of the present invention is built off of existing sewage treatment systems for further sanitation during the primary clarifying process and to prevent “sludge dumping”. The stages may be as follows: First, the sewage mixture may be transported through a sanitizing silver-lined trough. Second, it is pulverized with electrically powered rotary blades. Next, it moves via sanitizing trays to a heat treatment chamber to kill off bacteria. The mixture is then further sanitized with a UV light, and the remaining effluent is pressed at 3500 lbs. for rapid composting. Finally, a methane/saltwater treatment with chemical additives may be used to create the easily managed byproducts.

The method is configured to avoid sludge dumping. The sewage treatment method is a multistage process for sanitizing raw sewage and producing easily managed byproducts. Raw sewage or partially treated sewage is processed to remove and treat any liquids leaving sterilized solids that are compacted for limiting environmental impact. The method employs mechanical, thermal, radiation, and chemical treatments to the sewage to produce safe biodegradable materials. The treated final product is useful as fertilizer, fillers, aggregate, or compost instead of requiring costly disposal at a landfill.

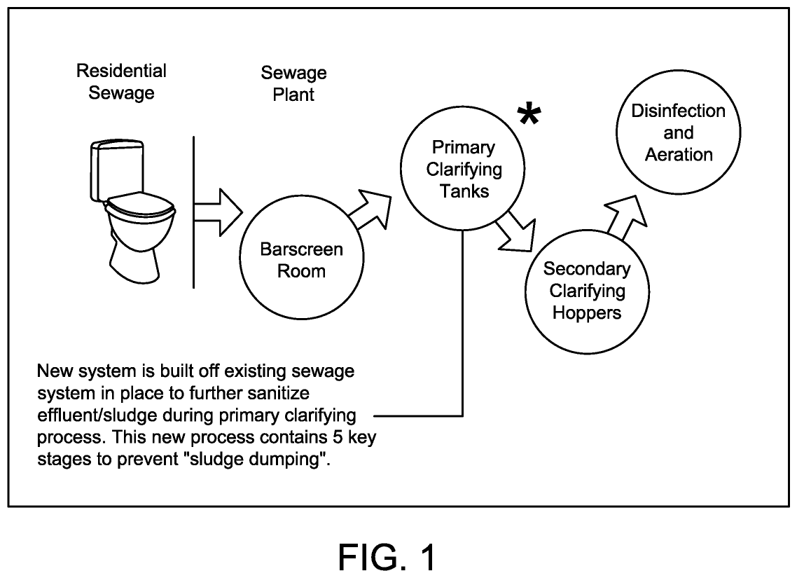

Referring initially to the drawings, FIG. 1 illustrates a prior art view of an existing municipal sewage system. Existing municipal sewage systems employ screening and clarifying processes prior to disinfection and aeration. The resulting sludge is difficult to deal with as it is still wet after traditional treatment. The wet sludge inhibits the destruction of pathogens. The wet sludge also takes up space and is not easy to dispose safely or economically. Individual septic systems face similar issues with final sludge disposition requiring removal or creating new leaching fields.

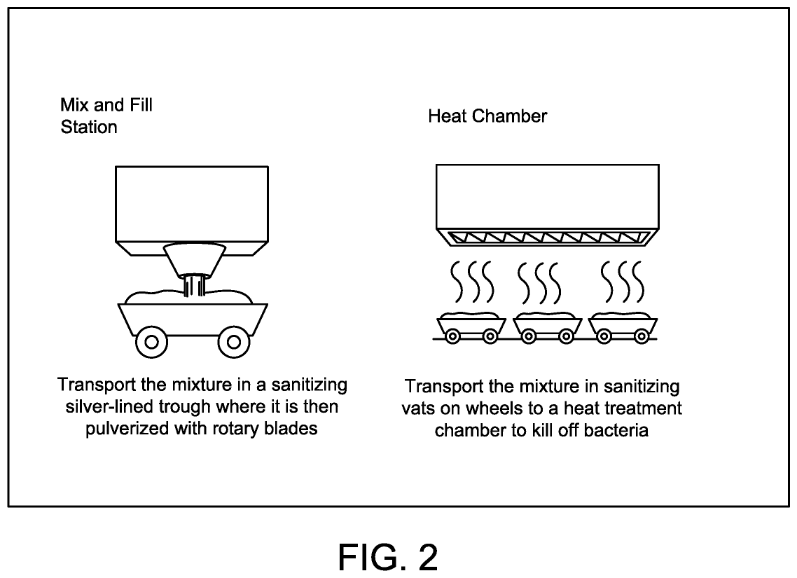

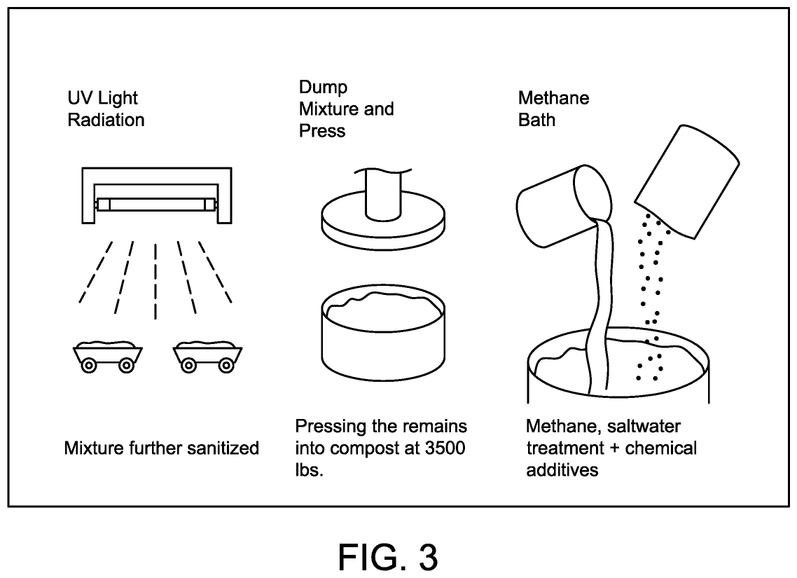

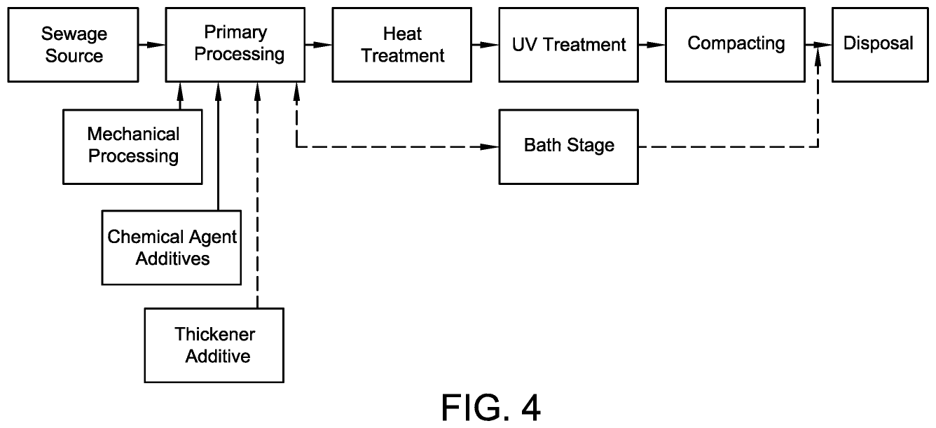

FIGS. 2-4 are used to schematically represent aspects of the present invention in the following exemplary embodiments. The present invention, in one embodiment, comprises a sewage treatment method. The method is useful for treating an initial sewage mixture. The sewage treatment method is configured for sanitizing and removing fluid from a sewage source, such as wastewater containing biosolids or sludge. The sewage treatment method is useful when the initial sewage mixture has been pre-treated via a municipal sewage treatment system such as illustrated in FIG. 1. The sewage treatment method is also useful when the initial sewage mixture has not been pre-treated via a municipal sewage treatment system.

The sewage treatment method begins by transporting the initial sewage mixture via conventional means, such as, but not limited to, pipes or transport vessels. The transport vessels may be lined with silver, copper, or other materials with antimicrobial properties. The transport vessels may be rail carts, tanks, barrels, or any similar mobile transport vessel. The sewage treatment method may be configured to treat small to large quantities of the initial sewage mixture ranging from fifty gallons and up.

The initial untreated or partially treated sewage mixture is both mechanically and chemically treated or processed during an initial processing stage, The initial processing stage mechanical manipulates the initial sewage mixture via pulverization. The initial sewage mixture is fed into a pulverizing apparatus via piping or other means and is pulverized via a plurality of electrically driven rotary blades. The purpose of the mechanical pulverization is to oxygenate the untreated sewage mixture and mix or blend in chemical agents simultaneously as discussed infra.

The initial processing stage further includes chemically treating the initial sewage mixture. A plurality of chemical agents are added to the initial sewage mixture during pulverization. The plurality of chemical agents typically include at least a base and an acid. The base is typically sodium bicarbonate, although it may be any other base usable for sewage treatment. The acid is typically garden lime, although it may be any other acid usable for sewage treatment. Mechanical mixing activates during the first stage of the process activates the acids turning the product into something else. The pulverizer oxygenates the mix affecting the boiling point and makes the product consistent.

At least one thickening agent may also be added during the mechanical manipulation of the initial sewage mixture. The thickening agent may include organic or inorganic materials. Local spoils may be a good source of thickening agents for economy. Examples of thickening agents in one embodiment include, but are not limited to, sand, pine straw, clay, or combinations thereof. The thickening agents are useful to thicken the mixture prior to the next step.

A saline solution may also be used to bathe the mechanically and chemically treated sewage mixture during this step. Salt is only added depended on the salinity of the tanks of water. Polluted salt water from old sewage outlets may be used when mix saturated with sodium bicarbonate is empty to run through the mixture instead of or in conjunction with the base. This is only done as needed. The taller the mixing tank and the smaller the bubbles produced, the more efficient the process becomes. In one example, approximately 15% by volume of liquid waste salt is only added to the saltwater tank if the salinity is the way 3.5 volume until the water mixture is fully suspended. At approximately 3.5% salinization or greater the process is 20 minutes or less depending upon volume. The saline solution may be alternatively added at a later step in the method. The saline solution may further include the addition of methane or another polarizing chemical additive as well.

Once the initial processing stage is complete, the mechanically and chemically treated sewage mixture is transported to the next stage. Transportation may be accomplished via a plurality of non-stick coated transport vessels, pipes, or other traditional transport containers. The mechanically and chemically treated sewage mixture is then heated sufficiently to kill off unwanted bacteria. Heating is accomplished through conventional heat sources and may radiated heat. Heating is generally continued until the sewage mixture is mostly dry. In one example, the heating stage may be between approximately 200 to 300 degrees Fahrenheit for at least 15 minutes, although temperature and time will vary depending on the individual conditions of each mechanically and chemically treated sewage mixture.

Once heated, the heated sewage mixture is transported to the next stage of the process for sanitization by applying radiation to the heated sewage mixture. The radiation source is typically ultraviolet light. The ultraviolet light may be generated via an artificial ultraviolet light source, a natural artificial ultraviolet light source, or a combination thereof. The ultraviolet light is applied for at least six minutes. Response to natural light plays a large factor in this step. On a bright day sanitization takes around six to twelve minutes on inclement weather using artificial sources, sanitization may take slightly longer, such as approximately fifteen minutes, as the light accelerates the rapid decomposition of the final product.

Once sanitized, the sanitized sewage mixture is transported to the next step for compaction. The sanitized sewage mixture is compressed at the compaction stage into a compact treated sewage solid byproduct. In one example, the radiated sewage mixture is compressed at approximately 3500 pounds of pressure, although the used pressure will vary depending on the individual conditions of each batch of the sanitized sewage mixture. Pressing the product is done in the last stage as the final treatment once all liquid is dried and the product sterilized by heat and ultraviolet treatment. Compression of the solids can be done on or off site. Pressing not only minimizes the space the final product takes up it also compounds elements for accelerated decomposition.

The compact treated sewage solid byproduct is then safely disposed at the final step of the process at a traditional landfill, for use as fertilizer products, or for use as in building or construction projects. The compact treated sewage solid byproduct is hygienic and odor free. In a nonexclusive list of examples, it can be used as filler for concrete, as an outstanding fertilizer, or it can be used as aggregate. It can also be laid under the line rock layer of new road construction. This application will compost even more rapidly.

Notwithstanding the forgoing, the sewage treatment method can be any suitable size, shape, and configuration as is known in the art without affecting the overall concept of the invention, provided that it accomplishes the above stated objectives. One of ordinary skill in the art will appreciate that the configuration of the sewage treatment method and its various components, as show in the FIGS. are for illustrative purposes only, and that many other configurations of the sewage treatment method are well within the scope of the present disclosure. Although dimensions of the sewage treatment method and its components (i.e., length, width, and height) are important design parameters for good performance, the sewage treatment method and its various components may be any configuration that ensures optimal performance during use and/or that suits user need and/or preference. As such, the components of the sewage treatment method may be comprised of sizing/shaping that is appropriate and specific in regard to whatever the sewage treatment method is designed to be applied.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A sewage treatment method comprising the following steps:
processing an untreated sewage mixture mechanically and chemically;
heating the mechanically and chemically treated sewage mixture;
applying radiation to the heated sewage mixture; and
compressing the radiated sewage mixture into a compact solid for disposal.

2. The sewage treatment method of claim 1, wherein the untreated sewage mixture is mechanically pulverized.

3. The sewage treatment method of claim 2, wherein the mechanical pulverization oxygenates the untreated sewage mixture.

4. The sewage treatment method of claim 1, wherein the untreated sewage mixture is chemically processed with a base and an acid.

5. The sewage treatment method of claim 4, wherein the base is sodium bicarbonate and the acid is garden lime.

6. The sewage treatment method of claim 1, wherein the untreated sewage mixture is chemically processed with a saline solution.

7. The sewage treatment method of claim 1, wherein the mechanically and chemically treated sewage mixture is heated to at least 300 degrees Fahrenheit for at least 15 minutes.

8. The sewage treatment method of claim 1, wherein the applied radiation is ultraviolet light.

9. The sewage treatment method of claim 8, wherein the ultraviolet light is applied via a combination of an artificial ultraviolet light source and a natural artificial ultraviolet light source.

10. The sewage treatment method of claim 8, wherein the ultraviolet light is applied for between six to fifteen minutes.

11. The sewage treatment method of claim 1, wherein the radiated sewage mixture is compressed at 3500 pounds of pressure.

12. A sewage treatment method for sanitizing and removing fluid from a sewage source, the sewage treatment method comprising the following steps:
mechanically manipulating an initial sewage mixture;
adding an acid and a base to the initial sewage mixture during the mechanical manipulation;
heating the mechanically and chemically treated sewage mixture;
sanitizing the heated sewage mixture via an ultraviolet source; and
compressing the sanitized sewage mixture into a compact solid for disposal.

13. The sewage treatment method of claim 12, wherein the initial sewage mixture has been pre-treated via a municipal sewage treatment system.

14. The sewage treatment method of claim 12, wherein the initial sewage mixture has not been pre-treated via a municipal sewage treatment system.

15. The sewage treatment method of claim 12 further comprising adding a thickening agent during the mechanical manipulation of the initial sewage mixture.

16. The sewage treatment method of claim 15, wherein the thickening agent is an organic material.

17. The sewage treatment method of claim 15, wherein the thickening agent is sand, pine straw, clay, or a combination thereof.

18. The sewage treatment method of claim 12 further comprising the step of bathing the mechanically and chemically treated sewage mixture in a saline solution.

19. The sewage treatment method of claim 18, wherein the saline solution is 3.5 percent saline.

20. A method of treating sewage comprising the following steps:
receiving sewage from a sewage source;
mechanically pulverizing the received sewage to oxygenate the received sewage;
adding an acid, a base, and at least one thickening agent to the received sewage during pulverizing;
bathing the mechanically and chemically treated sewage mixture in a saline solution;
transporting the pulverized and chemically treated sewage to a heat source via a non-stick coated transport vessel;
heating the pulverized and chemically treated sewage for at least 15 minutes. sanitizing the heated sewage with ultraviolet light for between six and fifteen minutes;
compressing the sanitized sewage at 3500 pounds of pressure;
disposing a treated sewage solid byproduct.
